(19) United States
(12) Patent Application Publication
(10) Pub. No.: US 2023/0392460 A1
(43) Pub. Date: Dec. 7, 2023

(54) SMART SYSTEM FOR EARLY KICK AND LOSS DETECTION DURING DRILLING OPERATIONS

(71) Applicant: ABBON AS, SANDVIKA (NO)

(72) Inventors: Cornelius Emeka Agu, Vøyenenga (NO); Ibrahim Saeed Alghamdi, Dammam (SA)

(21) Appl. No.: 17/830,603

(22) Filed: Jun. 2, 2022

(51) Int. Cl. E21B 21/08

(52) U.S. Cl. CPC E21B 21/08

(57) ABSTRACT

This present invention discloses a system used for real-time detection of kick by means of measurement of quantities and flowrates of all the components contained in a multiphase fluid stream returning from a drilling well for efficient operation of Managed Pressure Drilling (MPD). The system is equipped with multiple sensors for calculating flowrates, velocities, pressure, densities and volume of the multiphase fluid stream. In addition to these sensors, the system also includes a capacitive or conductive or both impedance sensors to measure the electrical parameters of the fluid stream followed by measuring a gas volume fraction in the multiphase fluid stream. Further, the system also includes a tomography measurement sensor for obtaining the velocity, concentration and particle size of the drilling cuttings in the multiphase fluid stream. Further, a set of models based on the physics of flow is developed and used in a computer program to obtain the flowrates and volume fractions of gas, oil, water, drilling fluid and drilling cuttings which directly give indication about kick and its size in drilling operation. In addition, the system also provides details about the circulation loss in real time during drilling operations.

### FIELD OF INVENTION

The invention generally relates to oil, gas and well drilling operations. More particularly, the present invention relates to a system for detecting a kick in a drilling well in early stage of drilling operations. The present invention also relates to a system and method for detecting the kick of a multiphase fluid stream returning from the drilling well for efficient operation of Managed Pressure Drilling (MPD) operations.

### BACKGROUND

Drilling process including fracturing of subterranean formations forms a basis and crucial step for oil/gas extraction. Fluid-based drilling refers to the process in which water or other fracturing fluid is introduced and maintained at high pressure in a wellbore. The need for maintaining high pressure is typically to prevent occurrence of “kick-backs” in drilling machinery. A typical drilling operation involves complex machinery, where an operation am mainly relies on manual procedures and skills to avert a “kick or gas kick”. This practice is neither standardized nor accurate for kick detection. Moreover, kicks may range in severity, and can result into blowout in which high pressure hot gas flows to the surface. Such conditions make a typical drilling operation dangerous, inefficient while lacking personnel safety assurance. There is growing need for innovative technologies to optimize the drilling operations in oil industries, particularly in complex structures. Such innovation is geared towards achieving efficient and economic operations, thereby reducing the non-productive time and improving on the associated safety issues.

The most peculiar challenge during drilling operation is the occurrence of kick or gas kick in particular. The kick is an influx of reservoir formation fluid into the wellbore due to positive difference between the formation pressure and the drilling wellbore pressure. Several factors can influence the kick, which include loss of drilling fluid circulation, insufficient drilling fluid density, transit behavior of the wellbore pressure due to relative movement of the drilling pipe during tripping process, high permeability of the reservoir, and low viscosity of the formation, among others.

Kicks can be identified in different degree of severity. If not properly managed, they can lead to blowout where high pressure hot gas flows to the surface, thus resulting in injuries, damage of equipment, loss of production hours and even to loss of lives. Pressure balancing in the borehole is often desired, and thus may be usually achieved by varying the drilling fluid properties. Drilling fluid is also designed to transport out heat and cuttings generated due to drilling actions.

Most of the methods and apparatus used to mitigate kick-back during Managed Pressure Drilling (MPD) circumvent the problem of multiphase nature of a fluid stream involved in typical drilling operation ranging across various industries. In most cases, the fluid stream contains a water phase, a gas phase, a solid phase or an oil phase dispersed within each other. The traditional approach employed is therefore to extract samples of either one or more of the phases from the fluid stream for further evaluation. The composition of the fluid stream especially plays important role for detection of kicks in real-time. Timely and precise measurement of kick-back during drilling operation is hence crucial for MPD operations. The MPD is designed to avoid continuous influx of fluid stream into the wellbore by using a combination of enhanced kick detention technique and other pressure management tools and sensors, such that the non-productive time is kept at the minimum.

In conventional drilling system, it is a usual practice to operate in an overpressure environment, that is a condition where the borehole pressure is higher than the reservoir pressure in order to minimize the potential kick. In addition, the conventional operation relies upon manual kick detection which depends on the competence and skills of the drilling crew. However, this practice is not efficient, and it can lead to continuous loss of drilling fluid, thereby increasing the operational cost. Moreover, in a complex formation or depleted reservoir, such operation is not suitable, facilitating a need for such advance technology as the Managed Pressure Drilling (MPD) system.

There are different methods proposed and patented for gas kick detection in pressure drilling operations. First, the most common is the “mud logging analysis” described in a research article “Real time advanced flow analysis for early kick/loss detection & identification of open fractures” by R. Al-Morakhi et al. The mud logging analysis involves measurement and analysis of different drilling fluid properties, but it does not however, offer real-time results.

There are various examples of patents explaining mud logging analysis. U.S. Pat. No. 4,492,865 describes a method and apparatus for logging borehole parameters during a drilling operation. Another U.S. Pat. No. 8,965,703 discloses a method for measuring down hole's drilling fluid as a function of time or as a function of depth. Although the method described in both patents gives precise information about the formation type, drilling fluid density and types of gas associated in the return well fluid, it generates a significant error when a significant volume of gas is present.

Another research paper entitled, “Early Kick Detection for Deepwater Drilling: New Probabilistic Methods Applied in the Field” by David Hargreaves describes development and field test of a sensitive new kick detection system. The detector uses a Bayesian probabilistic framework to make good decisions based upon noisy drilling data. It works on any rig type and brings particular improvements to kick monitoring for deep-water drilling, especially in high heave conditions. Although by statistical analysis of the historical information from nearby wells, fields and geological zones, the possibility of potential kick from a well can be detected, but the accuracy of this method entirely depends on the quality of the raw data.

A U.S. Pat. No. 9,109,433 discloses an apparatus, method and computer-readable medium for detecting a gas influx event in a borehole fluid during a drilling operation by applying the advance acoustic measurement such that early gas bubble as far as down the bottom of the well can be detected. However, the performance of the acoustic technique depends largely on some specific factors including its response frequency, drilling fluid type and the circulation rate.

A research paper entitled, “Gas—influx detection with MWD technology” by T. M. Bryant discloses an influx detection technique that monitors the acoustic responses of annular measurement-while-drilling (MWD) pulses to provide a rapid, early warning of the development of potential gas-kick situations. The technique has been evaluated in both water- and oil-based mud during about 40 gas-kick simulations at two full-scale testing facilities. Another research paper entitled, “Development and testing of kick detection system at mudline in deep-water drilling” by Jianhong hit discloses an early kick detection based on the Doppler principle, which enables the annular flow velocity of the drilling fluid to be measured, or timely kick detection in deep-water drilling. As described in these articles, both drilling fluid density and its injection rate have great influences on the acoustic measurement in the drilling operations.

Another PCT application WO2007089338 discloses tools and methods for identifying the influx of formation fluids such as gas, oil or water, into the borehole in real-time during drilling operations. Although the method described uses measurement of in elastically scattered gamma rays with a pulse neutron source, the measured carbon to oxygen ratio must be compared against the tabulated values for direct measurement of gas kick. For detection of influx of formation liquid (i.e., liquid kick), the method in addition requires knowledge of elemental composition of the reservoir fluid.

Several indicators can be used to monitor drilling operation against the occurrence of kick. Increase in flow rate, increase in pit volume and well flow with drilling fluid pump off offer direct warning signs about the kicks. As reviewed in “Kick detection and remedial action in managed pressure drilling: a review” by Mohammad Mojammel Huque, monitoring the changes in drilling fluid flow rates between the inlet and return lines is an effective means for efficient MPD operation. Continuous and accurate measurement of the mass flow rate and density of the drilling fluid ensures on-time prediction of the influx movement, thereby reducing the non-productive time. Changes in mass flow rate can also detect a kick quickly and the early detection can significantly reduce the kick size.

A US Publication number 202100317713 discloses a method where a flow chamber apparatus with three ultrasonic sensors is used to measure the drilling fluid flow rate and a pressure sensing apparatus with three differential pressure transducers is used to measure the direction of the fluid loss. Although the system described utilizes ultrasonic sensors to measure drilling fluid flow rate, the system is inefficient and does not provide any information regarding the other phases like gas and alike.

In most operations, a product named Coriolis flowmeter is applied for measuring flowrate of the return drilling fluid owing to its accuracy in single-phase flow measurement when the flow is continuous, and the conveying pipe is full. However, for efficient kick management, presence of intermediate operations such as tripping and reduction in fluid circulation rate limits its application in the MPD. The accuracy of Coriolis flowmeter also depreciates when the gas volume fraction or solid concentration or number of phases in the fluid stream increases. To minimize particle blockage in the vibrating tubes, a Coriolis flowmeter designed for MPD system can be extremely large, resulting in high pressure loss in the system.

There are various other flowmeters based on radioactive or non-radioactive technology that can be used to detect and measure flowrate of multiphase flow stream, mainly providing only the values of three fluid phases, e.g., gas, oil and water in flow returning from the wellbore.

To enhance the multiphase flow measurement devices for wider applications, a technique for measurement of four-phase flow system containing gas, oil, water and solids based on the non radioactive impedance measurements combined with two differential pressure signals measured across a venturi tube is presented in the 2021 North Sea Flow Measurement Workshop (NSFMW). The technique presented in the workshop utilizes the patented twin-flow technology, NO Patent number NO329758, which describes means of measuring physical and electrical properties of individual phases in a multiphase fluid flowing through a tube. Similar to the traditional three-phase meters, the computational models demonstrated in the workshop still rely on correlation of discharge coefficient, gas velocity to liquid or slurry velocity ratio, also known as slip, slurry density and the overall mixture density.

Considering the high accuracy and precision required in MPD operations, the method used in the traditional multiphase meters are not suitable for the drilling applications. In addition to high accuracy and precision, the MPD operations requires every apparatus connected in the process to operate in a close loop, that is, there should be a minimal human interference either by collection of samples for analysis or by continues update of input used in the process measurement.

The prior art described above discloses a number of conventional multiphase flowmeters and apparatus and methods with possibilities to detect kicks. However, the apparatus and methods so described are inefficient and ineffective. Therefore, the present invention is designed to address the peculiar challenges in the conventional multiphase meter for wider applications as well as meeting the requirements for efficient operations in the managed pressure drilling system (MPD).

Hence, to overcome the shortcomings of the prior arts, there is a need to provide a system for detecting kicks that is geared towards achieving efficient and economic operations, thereby reducing the non-productive time and improving on the associated safety issues. Thus, there is a need to provide a system for effectively managing kick that entirely depends on its appropriate and timely detection including its size when it occurs.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Thus, there is a need to provide a system for efficiently detecting kick and kick size in real-time during oil and gas drilling operations.

### SUMMARY OF THE INVENTION

In accordance with the present invention, the disadvantages and limitations of the prior art are substantially avoided by providing a system for detecting kick in real-time within a fluid stream returning from a drilling well for efficient operation of Managed Pressure Drilling (MPD) operation. The system includes a first sensor unit positioned on top or anywhere upstream of the drilling well. The first sensor unit includes a first impedance sensor for measuring first value of electrical parameters associated with the fluid stream entering the drilling well. Further, the first sensor unit includes a first detector module for measuring a first value of parameters associated with the fluid stream entering the drilling well.

The system further includes a second sensor unit positioned within the drilling well for monitoring the fluid stream returning from the drilling well. The second sensor unit includes a second detection module for measuring a second value of parameters associated with the fluid stream flowing out from the drilling well. Further, the second sensor unit includes a particle detector located below to the second detection module and to be used for measuring size and concentration of solids particles present within the fluid stream. The particle detector may also be used to measure flow velocity of solid particles or their mixture with liquid phase.

The system further includes a controller connected to the first sensor unit and the second sensor unit for obtaining the first value and second value of electrical properties, physical parameters, velocity, size and concentration of solid particles, and thereby detecting a probability of occurrence of kicks within the fluid stream of the drilling well.

The primary objective of the present invention is to provide a system for detecting kick in real-time within a fluid stream returning from a drilling well for efficient operation of the Managed Pressure Drilling (MPD).

Another objective of the present invention is to provide a system for efficiently detecting kick by measuring flowrate, density and volume fractions of water, oil and gas as fluid components within a fluid stream as well as size, concentration and volume fraction of solid particles within the fluid stream,

Yet another objective of the present invention is to provide a system for detecting influx of formation fluid into the drilling well accurately and intelligently by utilizing non-radioactive impedance technology for measurement of gas volume fraction, and a device such as venturi tube, which offers a restriction in the flow path of the fluid stream, thereby creating differential pressure used to calculate the total flowrate of the fluid stream.

Another objective of the present invention is to provide a system for detecting kicks thereby providing efficient and economic operations which reduces the non-productive time and improves on the associated safety issues related to the MPD operations.

Yet another objective of the present invention is to provide an improved system for detecting kick by accurately characterizing and measuring the concentration of the solid particles including the drilling cuttings in real-time.

Another objective of the present invention is to provide an improved system for accurately detecting kick and its size by eliminating use of correlations for measuring required parameters across the venturi tube.

Yet another objective of the present invention is to incorporate a system that uses pressure loss across a venturi tube for directly measuring the discharge coefficient, and a pair of differential pressures along two vertical pipes with flow in opposite direction, thereby enabling measurement of total mixture density required in calculating both flowrates and volume fractions of all phases within the fluid stream.

Another objective of the present invention is to provide an efficient system designed for managed pressure drilling system that detects kick and size in a multiphase fluid stream containing gas, oil, water and solid under a multi-fluid environment.

Yet another objective of the present invention is to provide a system for five-phase flow measurement and thereby detect kick within the fluid stream by analyzing a drilling fluid phase, a water phase, a gas phase, a solid phase and an oil phase.

In one embodiment of the present invention, the second detection module includes a sensing element for measuring a second value of multiple parameters associated with the fluid stream. Further, the sensing element includes a pair of vertical and parallel pipes placed within the drilling well at a specified distance for obtaining density of the fluid stream.

Further, the second detection module includes a flow restrictor placed within one part of the pipe for accelerating the flow of the fluid stream across the drilling well thereby measuring second value of parameters associated with the fluid stream. In one yet another embodiment of the present invention, the flow-restrictor is a venturi tube, a conical structure, an orifice plate and a wedge structure. Further, the second sensor unit includes a second impedance sensor for measuring second value of electrical parameters associated with the multiphase fluid stream. Further, the second impedance sensor may also be used for measuring velocity of one of gas phase, oil phase, water phase, solid phase and a mixture of two or more of the component phases.

In an alternative embodiment, the second detection module includes a flow restrictor placed within one part of the pipe for accelerating the flow of the fluid stream across the drilling well thereby measuring second value of parameters associated with the fluid stream. In one exemplary embodiment of the present invention, the flow-restrictor is a venturi tube for accelerating the flow of the fluid stream across the drilling well thereby measuring second value of parameters associated with the fluid stream.

In one another embodiment of present invention, the parameters measured is either flowrate, velocity, density, pressure, temperature, differential pressure, gas specific gravity, volume fraction of a solid phase within the fluid stream. The fluid phase includes a water component and an oil component within the fluid stream. In one yet another embodiment of the present invention, the electrical parameters measured is conductivity, permittivity, impedance, conductance associated with the fluid stream, thereby measuring volume fraction of a gas phase within the fluid stream. In one embodiment of the present invention, the fluid stream is a multiphase fluid stream. The fluid stream includes a gas phase, an oil phase, a water phase, a drilling fluid phase and a solid phase.

In one another embodiment of the present invention, the particle detector is selected from a tomography sensor including an electrical capacitance tomography (ECT), an electrical resistance tomography (ERT), an X-ray tomography, an imaging device, and a camera for measuring solid particles within the fluid stream. The solid particles are drilling bits, drilling cuttings, drill cuttings. In one exemplary embodiment of the present invention, the particle detector is an electrical capacitance tomography (ECT) sensor for measuring the solid particles within the fluid stream. In another exemplary embodiment of the present invention, the particle detector is a double plane electrical capacitance tomography (ECT) sensor for measuring the solid particles within the fluid stream. The solid particles are drilling bits, drilling cuttings, drill cutting, sand or alike. The double plane electrical capacitance tomography (ECT) sensor is positioned below the second detection module and used for measuring size and concentration of solids particles present within the fluid stream. The double plane electrical capacitance tomography (ECT) sensor may also be used to measure flow velocity of solid particles or their mixture within the liquid phase.

Other objectives and aspects of the invention wilt become apparent from the following detailed description, taken in conjunction with the accompanying drawings, which illustrate, by way for example, the features in accordance with embodiments of the invention.

To the accomplishment of the above and related objectives, this invention may be embodied in the form illustrated in the accompanying drawings, attention being called to the fact, however, that the drawings are illustrative only, and that changes may be made in the specific construction illustrated and described within the scope of the appended claims.

Although the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

Embodiments of the invention are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1(A) illustrates an overview of system used for detecting kick within a fluid stream in accordance with the present invention;

FIG. 1(B) illustrates an overview of a first sensor unit applied on top or upstream of a drilling well in accordance with the present invention;

FIG. 1(C) illustrates an overview of a second sensor unit applied within the drilling well in accordance with the present invention;

FIG. 1(D) illustrates an overview of alternative embodiment of a system used for detecting kick within a fluid stream in accordance with the present invention;

FIG. 1(E) illustrates the system applied on the drilling well in accordance with the present invention;

FIG. 2(A) illustrates a detailed view of a venturi tube as second sensor module applied in the drilling well in combination with other sensors for measuring flowrates in accordance with the present invention;

FIG. 2(B) illustrates a detailed view of a venturi tube as second sensor module applied in the drilling well for measuring flowrates in accordance with the present invention;

FIG. 3 illustrates a detailed view of a density measurement device positioned in a vertical orientation for measuring density of a mixture within the fluid stream in accordance with the present invention;

FIG. 4 illustrates a detailed view of a cone structure used as an alternative embodiment of a flow restrictor used in combination with the sensing element to measure flowrates within the fluid stream in accordance with the present invention;

FIG. 5 illustrates a detailed view of a wedge structure as an alternative embodiment of the flow restrictor used in combination with the sensing element to measure flowrates in accordance with the present invention;

FIG. 6 shows a detailed view of an orifice plate structure as an alternative embodiment of a flow restrictor used in combination with the sensing element to measure flowrates in accordance with the present invention;

FIG. 7 illustrates an exemplary embodiment of a tomography measurement device used as a particle detector for measurement of solid velocity, concentration and solid particle sizes in accordance with the present invention;

FIG. 8(A) illustrates a pixel arrangement for obtaining the image of the solid particles by the tomography measurement device within the flow pipe cross-sectional area in accordance with the present invention; and

FIG. 8(B) illustrates a detailed view of the image of the solid particles obtained by the tomography measurement device within the flow pipe showing how a cluster or a single particle can be distinguished from the drilling fluid in accordance with the present invention.

### DETAILED DESCRIPTION OF THE INVENTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “units” represents the dimension in any units such as centimeters, meters, inches, foots, millimeters, micrometer and the like, and forms thereof are not necessarily limited to members in a list with which the words may be associated.

In the description and claims of the application, each of the words “comprise”, “include”, “have”, “contain”, and forms thereof are not necessarily limited to members in a list with which the words may be associated. Thus, they are intended to be equivalent in meaning and be open-ended in that an item or items following any one of these words is not meant to be an exhaustive listing of such item or items or meant to be limited to only the listed item or items. It should be noted herein that any feature or component described in association with a specific embodiment may be used and implemented with any other embodiment unless clearly indicated otherwise.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems and methods are now described.

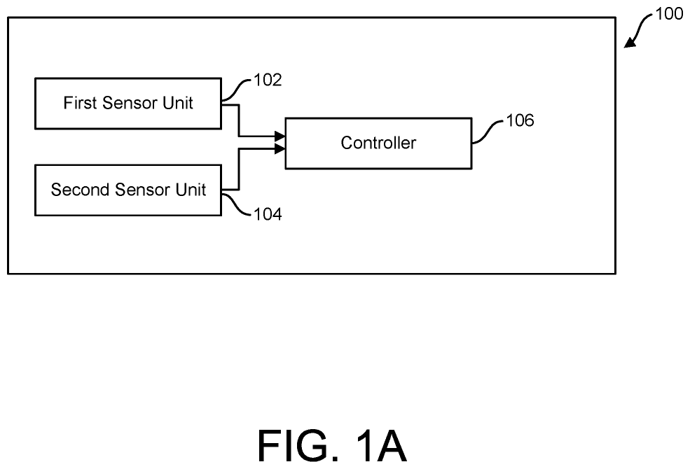

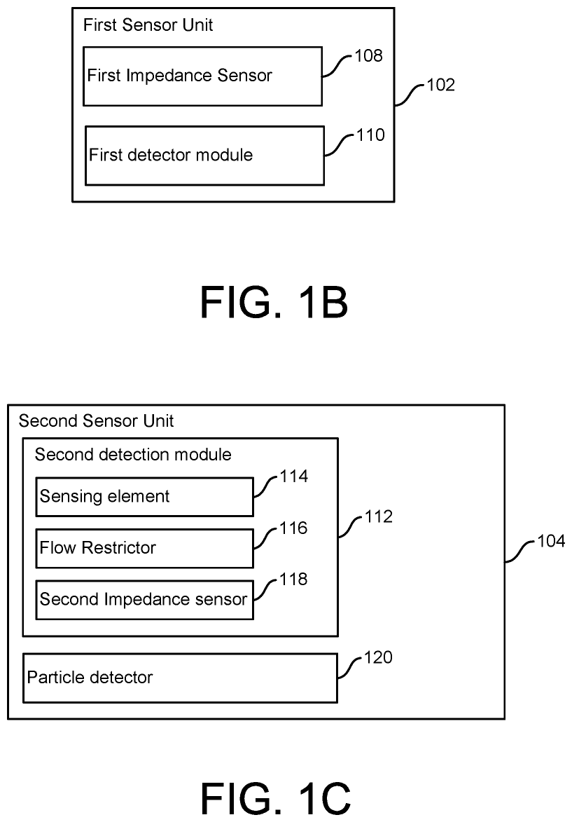

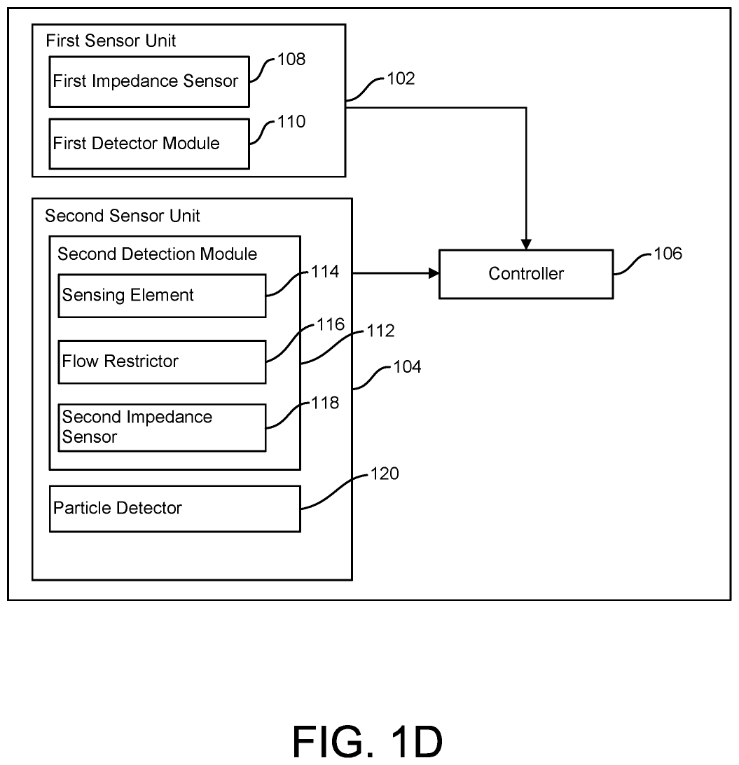

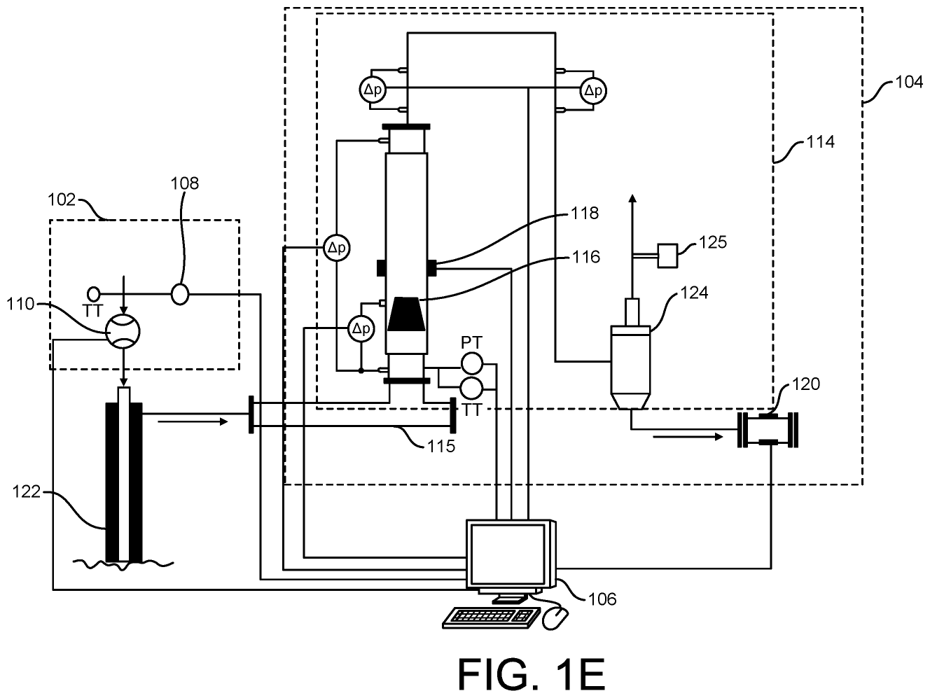

FIG. 1(A) illustrates a basic layout of all the principles and associated devices required for real-time kick detection using a system (100) of the present invention during Managed Pressure Drilling (MPD) operation. In the system, a fluid stream is considered as used for drilling a wellbore during oil and gas well drilling operations. Alternatively, the fluid stream may be any drilling fluid or flushing fluid used for drilling purposes. The drilling fluid may be water-based continuous fluid stream or oil-based continuous fluid stream that enters the drilling well. This fluid is used to lubricate drill bit and carry drill cuttings back to the surface for its removal from the drilling well. The drilling fluid may be a multiphase fluid containing as component: water, oil and solid particles.

The system includes a first sensor unit (102) positioned on top or anywhere upstream of a drilling well. The first sensor unit (102) is positioned to measure multiple parameters that are either physical or electrical-based parameters related to the fluid stream entering in the drilling well. Further, the system includes a second sensor unit (104) positioned within the drilling well along drilling path for measuring multiple parameters associated with the fluid stream returning from the drilling well, thereby detecting a kick within the fluid stream. The kick, in general is defined as an influx of reservoir formation fluid or drilling fluid into the wellbore or the drilling well due to positive difference between the formation pressure and the drilling wellbore pressure.

Further, the system (100) includes a controller (106) that reads and receives readings from the first sensor unit (102) and the second sensor unit (104). Both the first sensor unit (102) and the second sensor unit (104) are located near inlets and along drilling path, respectively. The first sensor unit (102) and the second sensor unit (104) detect various physical and electrical attributes of the fluid stream and relay the information to controller (106) for further processing of the data. Information obtained from the first sensor unit (102) and second sensor unit (104), and trends of information thereof is analyzed in real-time to effectively notify the occurrence and size of “kick backs” within MPD operation.

FIG. 1(B) clearly outlines the devices at the core of the first sensor unit (102). The first sensor unit (102) can either be located at the inlet of the drilling well or anywhere upstream of the second sensor unit (104). According to preferred embodiment of the present invention, the first sensor unit (102) includes two sub-units. Firstly, the first sensor unit (102) includes a first impedance sensor (108) placed on top of the drilling well. The first impedance sensor (108) measures conductivity, capacitance and other electrical parameters associated with the drilling fluid entering the drilling well.

The first sensor unit (102) further includes a first detector (110) positioned in proximity to the first impedance sensor (108). The first detector module (110) measures physical parameters associated within the fluid stream entering the drilling well. The physical parameters may be selected from flowrate, velocity, volume, density, and pressure or alike. In an alternative embodiment of the present invention, the first detector module (110) may be any flowrate measuring device, or flowmeter, multiphase meters or alike devices, which are used for measuring flowrate and density of the entering fluid stream in the drilling well.

FIG. 1(C) outlines the devices at the core of the second sensor unit (104) installed within the drilling well for measuring electrical or physical parameters related to the fluid stream. In a preferred embodiment according to present invention, the second sensor unit (104) is positioned downstream to the first sensor unit (102), along drilling path within the drilling well. The second sensor unit (104) is further divided into two further units, according to encompassing principles involved in sensing of attributes related to the fluid stream and flow mixture thereof.

According to the preferred embodiment of the present invention, the second sensor unit (104) includes a second detection module (112) for measuring physical or electrical parameters associated with the fluid stream returning from the drilling well. The second detection module (112) further includes a sensing element (114), a flow restrictor (116) and a second impedance sensor (118) for measuring physical parameters such as pressure, temperature, differential pressure, velocity, specific volume, density and electrical parameters such as conductivity or capacitance and a like parameters.

The sensing element (114), in a preferred embodiment, is a simple tube that is inserted in the drilling well and it includes a pressure sensory element or other sensory device that is in direct contact with gas, oil, water, or any other fluid component or fluid mixture flowing through the tube along the path of the fluid stream returning from the drilling well. The sensing element (114) also has a means or other means to identify pressures, temperature and the resulting differential pressures across the locations at which these units are mounted or across either one of the locations itself. In one of the embodiments according to the present invention, the pressure differential is calculated using the flow restrictor (116) attached to the second detection module (112). The sensing element (114) and the flow restrictor (116) play important role in calculating differential pressures and related characteristics of the fluid stream.

Further, the second detection module (112) includes a flow restrictor (116) positioned along the tube to restrict the flow of the drilling fluid or influx of the returning fluid from the drilling well, thereby accelerating the flow of the fluid and thereby helping in measurement of volumetric flowrate, differential pressure, density of the drilling fluid or influx of the returning fluid from the drilling well. The flow restriction caused by the flow restrictor (116) occurs due to lower diameter than that of the drill path pipe the restrictor has while retaining the fluid stream, thus restricting the flow of the fluid stream along the path of the tube or the drilling well.

In an alternative embodiment of the present invention, the flow restrictor (116) may be a venturi tube, a conical flow-restricting structure, a wedge flow-restricting structure. In further alternative embodiment according to present invention, an orifice plate may be applied as flow restrictor along the tube to cause a flow restriction with opening diameter smaller than the drill path pipe. The alternative embodiments of the flow restrictor or flow constriction structures have the same measurement principles as the venturi tube.

Further, the second detection module (112) includes a second impedance sensor (118) for measuring associated electrical parameters associated with the fluid stream. The electrical parameters may be a conductivity, impedance, permittivity, conductance associated with the fluid stream, thereby measuring volume fraction of a gas phase within the fluid stream returning from the drilling well, thus detecting the occurrence of kick within the fluid stream. The second impedance sensor (118) may be similar in working principle to the first impedance sensor (108). Further, the second impedance sensor (118) may be configured to also measure the velocity of fluid mixture or individual phase component including gas phase, oil phase, water phase, solid phase.

The signals regarding the fluid stream and its flow parameters using the sensing element (114) and flow restrictors (116) are prone to errors, especially in view of solid particles or drill cuttings present along with continuous liquid phase of the fluid stream. Therefore, a particle detector (120) is installed for measuring the particle size and concentration.

Further, the second sensor unit (104) includes a particle detector (120) for measuring sizes and concentrations of the solid particles within the returning flow stream from the drilling well. The particle detector (120) may be an electrical capacitance tomography (ECT), an electrical resistance tomography (ERT), an X-ray tomography, an imaging device, and a camera and a like device. Also, the particle detector (120) may be configured for measuring velocity of the solid particles in the fluid stream, and in another alternative, the measured particle velocity may be attributed equally to oil-water mixture.

In one embodiment of the present invention, the particle detector (120) may include a tomography sensor and a camera in addition to view, detect and measure the concentration and particle size of drilling cuttings in the fluid stream. The use of particle detector (120) in the second sensor unit (104) eliminates the use of intrusive or radioactive methods involved with sampling solid particles in typical MPD operations. The particle detector may be present anywhere downstream or before exit of totality of the fluid stream path, as an alternate embodiment of the present invention.

FIG. 1(D) illustrates the connections, inter-connections of all the devices and principles involved in FIG. 1(a)-1(c), with emphasis on role of the controller (106) in predicting kick-back or kicks using all the modules disclosed herein. The fluid stream follows through the path along drilling operation in such a way that different sensor units and devices along the fluid stream generate proper signal readings for calculation and processing by the controller (106) in predicting kicks by the system of present invention.

The fluid stream proceeds downstream into the bore-well and again upstream into a flow conditioner (115). According to preferred embodiment of the present invention, the role of the flow conditioner (115) is to homogenize the multiphase contents of the fluid stream, before entering part of bore well shaft housing other components of the system.

All the signals generated from the first sensor unit (102) and the second sensor unit (104) is fed to the controller (106) and a computer associated with it to produce the required outputs including the flowrate of the original fluid stream, the total flowrate of exit fluid stream, etc.

In one aspect of the present invention, the influx of gas or oil from the reservoir to the wellbore or the drilling well is calculated directly from physical measurement of downstream characteristics of the flow stream. No reference is made to flowrate measured at inlet to bore-well or drilling well in detecting the kick and its size. The mass flowrate of the fluid stream measured at inlet can still provide useful information about the loss of drilling fluid to reservoir or influx of water to the wellbore.

In all embodiments of the present invention, all the equations mentioned herein based on the underlying principles of fluid dynamics and hydrostatics are used to create an algorithm for calculation of flowrates and volume fractions of gas, oil, water, drilling fluid and cuttings as well as calculation of the drilling cutting size. The readings provided by sensors and particle detector, including the velocity, number and size of solids flowing through the fluid stream and other fluid variables including fluid density and density of mixture of liquid and drilling cuttings, are recorded and computed using the controller.

FIG. 1(E) is a brief overview of application of the system described in FIG. 1(A)-FIG. 1(D) and its use for real-time detection of a kick within a fluid stream in a drilling operation. As illustrated in FIG. 1(E), the fluid stream enters the bore-well or the drilling well (122) for drilling the wellbore. The fluid stream may be water-based drilling fluid stream or oil-based drilling fluid.

At the inlet of the drilling well (122), a first impedance sensor (108) is positioned on top for measuring impedance, conductivity, temperature, capacitance and alike parameters associated with the fluid stream entering the drilling well for drilling the well. In alternative embodiment of the present invention, the first impedance sensor also measures permittivity and temperature of the drilling fluid entering the drilling well (122).

Further, a first detection module (110) positioned in proximity to the first impedance sensor (108) is used for measuring flowrate, density and volume parameters associated with the fluid stream. Alternatively, any flowmeter or multiphase flowmeter may be used in lieu of measuring the mass flowrate, viscosity and density of the fluid stream before the fluid stream enters the bore-well.

Further, on the exit side of the bore-well or the drilling well, the fluid stream enters a flow conditioner (115) to homogenize all the components including gas, solid, drilling fluid, water and oil before entering the second sensor unit (104). Alternatively, the flow-conditioner (115) is used to improve the flow quality of the fluid stream and works as flow churner or blender in principle. Gas phase appears when there is ingress of formation fluid into the bore-well, which indicates possibility of “kick”. Oil and water phases can be part of the original drilling fluid stream or parts that have flown from the reservoir itself. The presence of such components of formation fluid in the process fluid stream predicts occurrence of the “kick”.

Further, the fluid stream enters a second sensor unit (104) for further estimation of the relevant physical and electrical parameters associated with the fluid stream returning from the drilling well, thereby providing information about the probability or chances of kicks associated with the fluid stream.

Further, the fluid stream enters a second detection module (112) for estimating the physical parameters including volume, mass, flowrate, and density of the fluid stream. The fluid stream enters a sensing element (114) of the second detection module (112) used for measuring density, volume fraction and mass flowrate associated with the fluid stream. In a preferred embodiment of the present invention, the sensing element (114) is a tubular element, placed within the drilling well. In one embodiment of the present invention, the tubular element includes a venturi tube, in which differential pressure, density and volume fraction is measured.

Alternatively, the sensing element (114) includes a five-phase flowmeter for measuring flowrate of components within the fluid stream. The components may be gas, oil, drilling fluid, solid particles and water. Further, the second detection module (112) include a multiphase flowmeter for measuring densities and mass flowrate of the fluid stream returned from the drilling well, thereby measuring a kick and its size. After measurement of the total mass flowrate, the flow stream enters a gas separator (124) configured for removing a gas phase from the fluid stream. After leaving the gas separator (124), when the gas phase is removed, only the slurry, i.e., a mixture of oil/water/drilling fluid and the solid particles remained in the flow stream. The solid particles consist of solids dispersed in the fluid stream and the drilling cuttings generated by drilling through the surface of the earth during drilling processes.

Further, the flow stream enters a particle detector (120) for detecting size, velocity and concentration of the solid particles in the flow stream. In one embodiment of the present invention, the particle detector (120) is a tomography measurement device or tomography sensor for measuring the size, concentration and characteristics of the solid particles that include drilling cuttings, drill bits. In yet another embodiment, the tomography sensor is part of the second sensor unit used for particle detection based on the principle of tomography imaging and image reconstruction to aid in accuracy of kick prediction by a controller.

Further, the readings associated with the physical and electrical parameters associated with fluid stream enters a controller (106) including a computer program that analyzes all the readings from the first sensor unit (102) and the second sensor unit (104), and further yields a probability of occurrence of kicks associated with the fluid stream. Alternatively, the controller (106) may be a flow computer including a computer program for analyzing all the inputs and the readings from the first sensor unit and the second sensor unit and yields a probability of occurrence of kicks associated with the fluid stream.

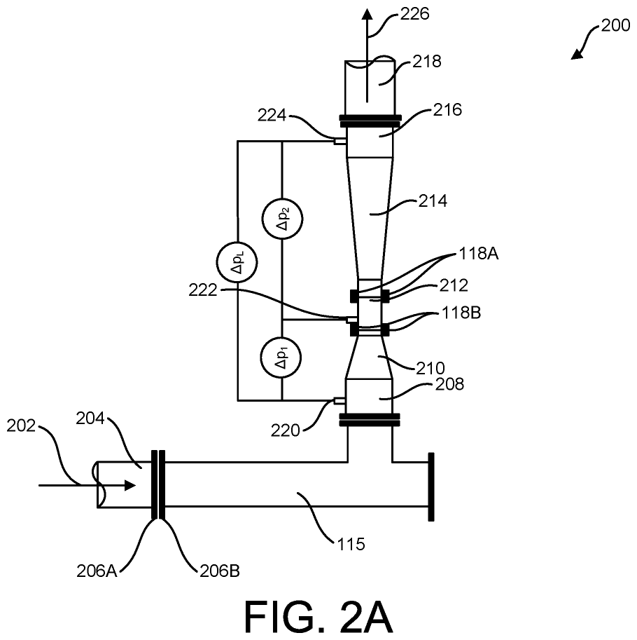

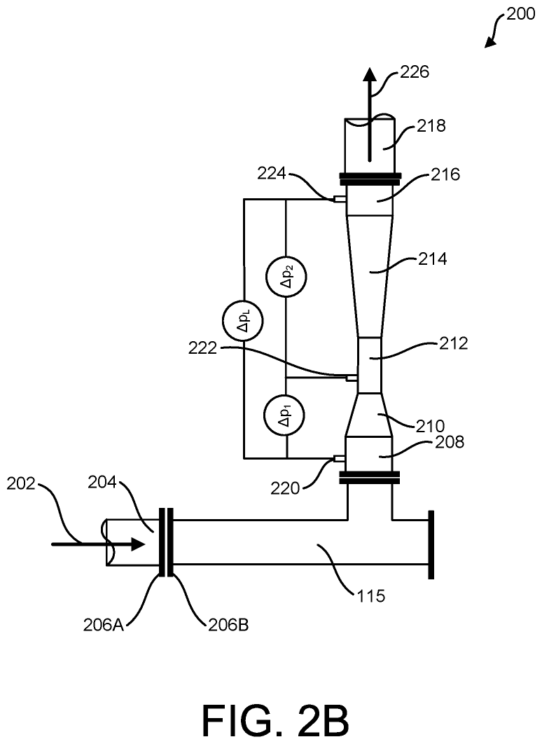

FIG. 2(A) illustrates a detailed view of a venturi tube (200A) embodied with a sensory element (114) and a flow restrictor (116) of the second detection module (112) applied in the drilling well. The sensory element (114) is applied in combination with other sensors for measuring flowrates and densities as described. The fluid stream (202) enters into the drilling well from the first sensor unit (102) and then to the second sensor unit (104) for further review of the parameters associated with the fluid stream. Firstly, the fluid stream (202) enters into a tube-like structure (204). Further, the tube includes a pair of flanges (206A, 206B) for connection to the return path of the drilling well.

The fluid stream (202) enters the flow conditioner (115) for homogeneously mixing the fluid content before entering the second sensor unit (104). The fluid stream enters a sensing element (114) used for measuring density, volume fraction and mass flowrate associated with the fluid stream. In a preferred embodiment of the present invention, the sensing element (114) is a tubular element, placed within the drilling well. In one embodiment of the present invention, the tubular element is a venturi tube, in which mass flowrate, differential pressure, density and volume fraction is measured. Further, the venturi tube (200) is a flow measurement device by which the flow cross-sectional area is constricted.

As shown in FIG. 2A, the venturi tube (200A) is an upstream flow pipe including an entrance pipe (208), a first conical pipe (210), a throat (212), a downstream flow pipe (216) and a second conical pipe (214). In a preferred embodiment according to present invention, the entrance pipe (208) serves to allow entrance of the fluid stream and the downstream flow pipe (216) as an exit for the fluid stream. The throat (212) is a straight pipe constituting the smallest cross-sectional area, and it is connected to the downstream flow pipe (216) through the second conical pipe (214). Further, the throat (212) serves the same purpose as the flow restrictor (116) generalized in FIG. 1(A)-1(E). The gradual decrease and increase of the cross-sectional area of the venturi tube (200) occurs along the first conical pipe (210) and the second conical pipe (216), respectively.

Between the upstream and downstream pipes (208, 216), the venturi tube (200) further includes a first connecting port (220) and the throat (212) further includes a second connecting port (222), whereby a differential pressure sensor is positioned to measure the difference in pressure. The differential pressure is calculated when the sensing element (114) is connected to measure the difference in pressure Δp₁ [Pa], also called the primary differential pressure generated when the fluid stream moves from the large to the low cross-sectional area according to the conservation laws of energy and mass.

Further, a second connection is made between the second connecting port (222) and the third and downstream port (224), to measure the differential pressure Δp₂ [Pa] recovered after the flow mixture passes through the throat section of the venturi tube. Further, the total pressure loss Δp_{L} [Pa] is measured between the upstream pipe and the downstream flow pipes through the connection ports (220, 224). In a preferred embodiment of the present invention, the first pressure port (220), the second pressure port (222) and the third pressure port (224) are selected in a way to prevent blockage of the pressure transmission lines by solid particles suspended in the fluid stream entering the venturi tube.

Any of the differential pressure sampling ports, the first pressure port (220), the second pressure port (222) and the third pressure port (224) can be either a small hole or aperture, in more general a tapping, where the fluid stream is directly in contact with the sensing element, or a diaphragm port where the fluid stream has no contact with the sensing element.

To prevent the potential blockage of the pressure transmitting ports i.e., the first pressure port (220), the second pressure port (222) and the third pressure port (224) by the solid particles carried in the fluid stream, a seal diaphragm port with fluid-filled capillary tube for transmitting the pressure is a preferred alternative embodiment in this invention.

By energy conservation, the three differential pressures Δp₁ measured between the upstream flow pipe and the throat, Δp_{L} measured between the upstream pipe and the downstream flow pipes and Δp₂ measured between the throat and the downstream flow pipe are related.

Δp₁=Δp_{L}+Δp₂ (1)

Eq. (1) indicates that when any two of the differential pressures Δp₁, Δp_{L} and Δp₂ are known, the other can be found. The mass flowrate and the volumetric flowrate of the fluid stream through the venturi tube can be obtained from the following equations which are well-documented in fluid dynamics textbooks.

$${\dot{m}}_{m} = {β}^{2} A C \sqrt{\frac{2 {ρ}_{m} ( Δ {p}_{1} + {g}_{z} {L}_{1} )}{1 – {β}^{4}}} \qquad ( 2 )$$

$${Q}_{m} = \frac{{\dot{m}}_{m}}{{ρ}_{m}} \qquad ( 3 )$$

where \dot{m}ₘ[kg's] is the total mass flowrate of the fluid stream, Qₘ [m³/s] is the volumetric flowrate of the stream and

$$A = \frac{1}{4} π {D}^{2} [ {m}^{2} ]$$

is the cross-sectional area of the entrance pipe with diameter D [m], L₁ is the distance between a first pressure port (220) and a second pressure port (222) over which the differential pressure Δp₁ is measured and g_{z} is the component of the gravitational constant in the downward direction.

When the flow is horizontal through the venturi tube, g_{Z}=0; when it is upward, g_{z}=−g and when it is downward, g_{z}=g, where g=9.81 [m/s²] is a constant.

β[-] is defined as

$$β = \sqrt{\frac{{A}_{th}}{A}} \qquad ( 4 )$$

where Aₜₕ is the cross-sectional area of the throat or the minimum flow area along the sensing element(s) as described for a flow restrictor (116).

A flow coefficient, C[-] accounts for both frictional loss and possible flow expansion depending on the flow condition, properties of the fluid stream and geometry of the measurement device. Generally, the flow coefficient is obtained from experiments and usually correlated with the flow Reynolds number, Re defined as in Eq. (5), where \dot{m}[kg/s] is the mass flow rate of the fluid stream with dynamic viscosity, μ[Pa·s]. Considering the limitation of empirical correlations in every measurement, the present invention uses an analytical approach based on energy and mass balances to obtain the value of C at a given flow condition.

$$Re = \frac{4 \dot{m}}{π D μ} \qquad ( 5 )$$

FIG. 2(B) illustrates a venturi tube (200B) without the second impedance sensor (118). Similar to venturi tube (200A), structural features of the venturi tube (200B) are as disclosed in FIG. 2(B). Further, the measurement principle used in venturi tube (200B) for measuring the total mass \dot{m}ₘ and volumetric Qₘ flowrates of the fluid stream is identical as disclosed in Eq. (1)-Eq. (5).

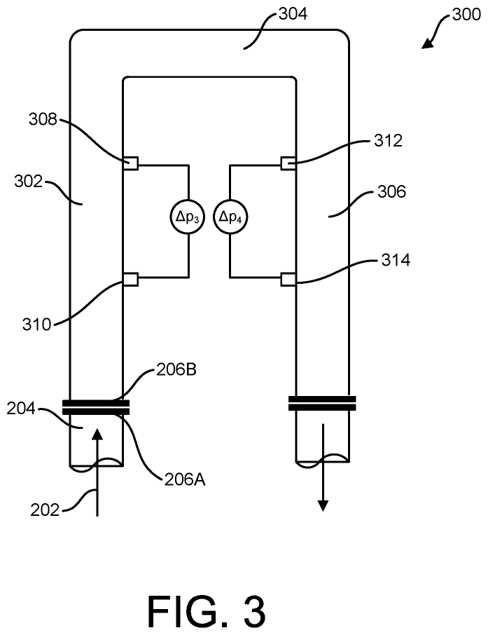

Further, the bulk density ρₘ of the flow stream is directly measured with a density measurement device (300) as shown in FIG. 3 through which the flow stream (202) leaves the venturi tube (200) for gas separation in the device (124).

FIG. 3 illustrates a density measurement device (300) in accordance with the present invention. The density measurement is based on the hydrostatic principle, and therefore the measurement device (300) is positioned in a vertical orientation. The vertical orientation of the setup with respect to gravity as illustrated is necessary for applying hydrostatic principles to measure density.

The tube (300) includes an inlet portion (302), having the same diameter as the inlet of the flow stream. Further, the tube (300) includes a first portion (302) as one part of the device that measures differential pressure Δp₃ between two ports (308, 310). Further, the tube (300) includes a middle portion (304) that is further connected to a second portion (306). The second portion (306) serves as a second part of the device that measures the differential pressure βp₄ between two ports (312, 314) on the part. The distance between the connecting ports (308, 310) for measurement of the differential pressure Δp₃ and the distance between the connecting ports (312, 314) for measurement of the differential pressure Δp₄ are the same.

Alternatively, a remote seal diaphragm port with a fluid-filled capillary tube is used for each of the connecting ports (308, 310, 312, 314) for measurement of the respective two differential pressures Δp₃ and Δp₄ so that the indicated differential pressures further includes component due to gravity. An expression for the mixture density is given by Eq. (6), where Δp_{eff} is the effective pressure drop combining the readings of the differential pressures Δp₃ and Δp₄, and h[m] is the distance between the connecting ports over which the differential pressures Δp₃ or Δp₄ is measured.

$${ρ}_{m} = \frac{Δ {p}_{eff}}{{g}^{h}} \qquad ( 6 )$$

Further, the second detection module (112) encompassing FIG. 2(A) includes a second impedance sensor (118) for measuring electrical property of the fluid stream. Depending on the electrical properties of the continuous liquid phase in the flow mixture within the fluid stream, the second impedance sensor (118) can either be conductive or capacitive. For water-based drilling fluid, it is expected that the liquid phase is water-continuous, thus a conductive impedance sensor (118) is used for the gas fraction calculation. When the drilling fluid is of oil-continuous type, capacitance impedance is applied to be able to have a valid electrical property of the flow mixture for calculation of the gas volume fraction.

The second impedance sensor (118) may further consist of two identical parts (118A, 118B) separated at a defined and fixed distance, such that the signals from each part at any point in time is identical but the arrival of a signal from part (118A) to part (118B) may be delayed by a certain time interval depending on the flow condition due to the distance between the two parts.

Where the fluid mixture is water-continuous, the gas volume fraction α_{g} is obtained as follows, first based on the mixing rule proposed by Bruggeman which is widely applied in multiphase flow measurement.

$${α}_{g} = 1 - {( \frac{{σ}_{m}}{{σ}_{slurr}} )}^{\frac{2}{3}} \qquad ( 7 )$$

In Eq. (7), σₘ[S/m] is the electrical conductivity of the flow mixture measured by the conductive impedance sensor, which may be readings from either part (118A) or (118B) of the second impedance sensor or weighted average of readings from the two parts (118A, 118B). σₛₗᵤᵣᵣ[S/m] is the conductivity of the mixture in the fluid stream comprising other phases than the gas phase, which can be obtained by applying the mixing rule below when it is taken that the drilling cuttings from the mineral rocks below the earth surface are not electrically conductive.

σₛₗᵤᵣᵣ=σ_{liq}(1−Øₛ)^{m}^{_{c}} (8)

In Eq. (8), the exponent m_{c} has values in the range 1.8-2 for sand-like particles, but the appropriate value for drilling cuttings is obtained by experiments for accurate measurement. σ_{liq}[S/m] is the electrical conductivity of mixture of oil and drilling fluid in the fluid stream, and is obtained from

$${σ}_{liq} = {σ}_{d} {\{ \frac{{α}_{d}}{( 1 - {∅}_{s} ) ( 1 - {α}_{g} )} \}}^{\frac{3}{2}} \qquad ( 9 )$$

The drilling fluid electrical conductivity σ_{d} [Sim] is strongly affected by the operating temperature. The value of σ_{d} used in this invention is related to the electrical conductivity of the drilling fluid measured with the conductivity sensor (108) described in FIG. 1(A)-1(E) as the first impedance sensor (108). A function relating the drilling fluid conductivity at the flow measurement location to the temperature t[C] of the fluid stream at the same location, and the conductivity σ_{d,ref}[S/m] and temperature t_{ref}[C] measured at the inlet of the drilling well is denoted as

σ_{d}=f(σ_{d,ref},t_{ref},t) (10)

For the case of oil-based drilling fluid where the liquid phase flow is oil-continuous, the gas volume fraction α_{g} is obtained using the following mixing rules described by Eq. (11)-(13), where εₘ[-] is the relative permittivity of the flow mixture measured by the capacitive impedance sensor (118), which may be readings from either parts (118A) or (118B) of the second impedance sensor or weighted average of readings from the two pans (118A, 118B). ε_{g}[-] is the relative permittivity of the gas phase and εₛₗᵤᵣᵣ[-] is the relative permittivity of the mixture in the fluid stream comprising other phases than the gas phase, which can be obtained by applying the mixing rule in Eq. (12) when it is taken that the drilling cuttings from the mineral rocks below the earth surface are not electrically conductive. ε_{liq}[-] is the relative permittivity of mixture of oil, water and drilling fluid in the fluid stream and εₛ[-] is the relative permittivity of drilling cutting particles. ε_{d}[-] is actually the relative permittivity of mixture of all the non-conductive liquid phases, mainly the drilling fluid and the formation oil, but can be taken as the relative permittivity of the drilling fluid for simplicity.

$${α}_{g} = 1 - ( \frac{{ε}_{m} - {ε}_{g}}{{ε}_{slurr} - {ε}_{g}} ) {( \frac{{ε}_{slurr}}{{ε}_{m}} )}^{\frac{1}{3}} \qquad ( 11 )$$

$${ε}_{slurr} = {ε}_{liq} + 3 {∅}_{s} {ε}_{liq} [ \frac{{ε}_{s} - {ε}_{liq}}{{ε}_{s} + 2 {ε}_{liq} - {∅}_{s} ( {ε}_{s} - {ε}_{liq} )} ] \qquad ( 12 )$$

$${ε}_{liq} = {ε}_{d} {\{ \frac{1}{1 - [ \frac{{α}_{d}}{( 1 - {∅}_{s} ) ( 1 - {α}_{g} )} ]} \}}^{3} \qquad ( 13 )$$

The concentration of the drilling cuttings Øₛ in the slurry is related to the solid volume fraction αₛ as in Eq. (14), which forms the first part for calculating the volume fraction of different phases in the fluid stream.

αₛ=Øₛ(1−α_{g}) (14)

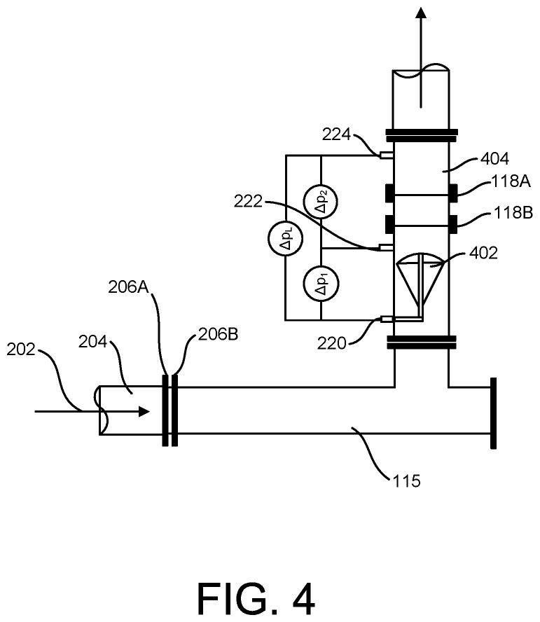

FIG. 4 illustrates a detailed view of a cone structure (402) used as an alternative embodiment of a flow restrictor (116) used in combination with the sensing element (114) to measure flowrates within the fluid stream. In a preferred embodiment according to the present invention, the flow restriction is used for sampling the fluid stream and measuring the flow rate and related parameters associated with the flow stream. The role of the cone structure (402) is to restrict the flow to the first pressure port (220) by virtue of the shape of flow restricting structure. As shown in FIG. 4, a bore pipe diameter (404) and the diameter of the cone (402) are the same and encompass the diameter of bulk flow of the fluid stream.

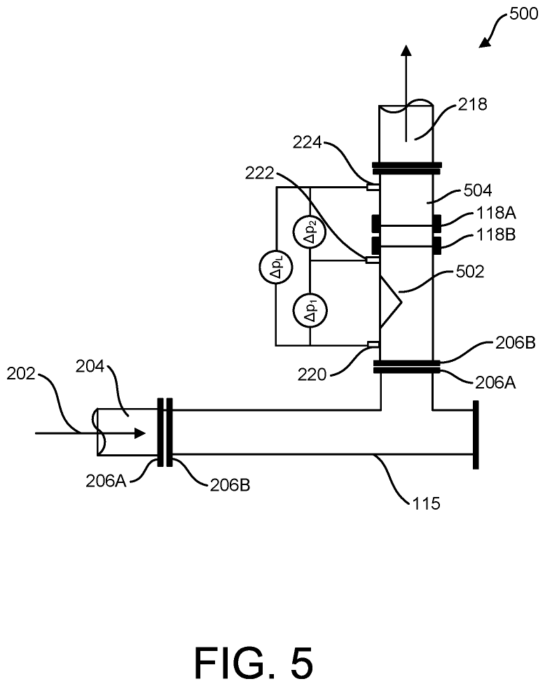

FIG. 5 illustrates a detailed view of a wedge structure (502) as an alternative embodiment of a flow restrictor (116) used in combination with the sensing element (114) to measure flowrates in accordance with the present invention. The wedge-can (502) is used as the flow restrictor (116) in combination with the sensing element (114) and other sensors to measure flowrate of the fluid stream during drilling operations. A bore pipe diameter (504) and the diameter of the wedge-can (502) are the same for retaining the fluid stream and the restricting element.

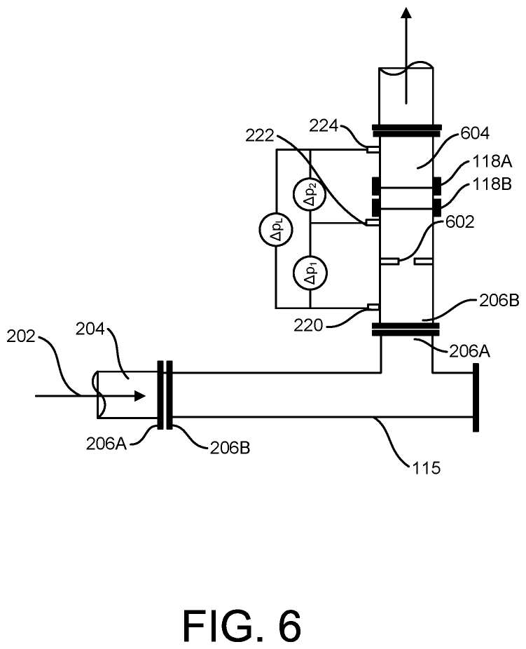

FIG. 6 shows a detailed view of an orifice plate structure (602) as an alternative embodiment of a flow restrictor (116) used in combination with the sensing element (114) to measure flowrates in accordance with the present invention during drilling operations. In a preferred embodiment of the present invention, the flow restriction is a method used for sampling the fluid stream and measuring the flow rate and related parameters associated with it. The role of the orifice plate (602) is to restrict the flow to the first pressure port (220) by virtue of the shape of flow restricting structure, i.e., orifice plate (602). The orifice plate (602) is principally a plate that has an aperture in the middle of it; therefore, the bore pipe diameter (604) is considerably reduced by using an orifice plate (602) along the diameter of bulk flow of the fluid stream.

Further, the volume fraction Ø_{S} of drilling cuttings in the solid-liquid mixture is obtained by means of a tomography measurement sensor installed immediately after the setup used to remove the gas phase.

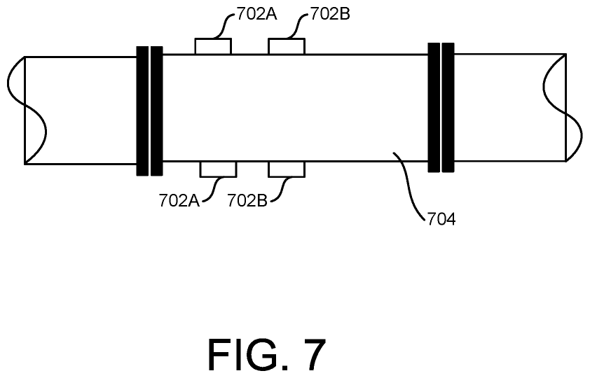

FIG. 7 illustrates an exemplary embodiment of a tomography measurement device used as a particle detector (120) for measurement of solid concentration and solid particle sizes in accordance with the present invention. The particle detector (120) as shown herein works on the underlying principle of tomography imaging. The particle detector (120) can be an electrical capacitance tomography (ECT) or an electrical resistance tomography (ERT) or an X-ray tomography. Since ECT is non-intrusive, well-developed and widely used in industries for visualization of behavior of complex processes, the current invention focuses on ECT as a device for measuring the concentration and particle size of drilling cuttings in the fluid stream.

According to one of the preferred embodiments of the present invention, the ECT sensors (702A) or (702B) are mounted at periphery of the bore-well pipe (704) containing the fluid stream flowing within. In general, ECT is used to measure the relative permittivity between two partially- or non-conducting phases. The output of the particle detector (120) is a distribution of normalized relative permittivity of the two-phase system within the cross-section of the bore-well pipe.

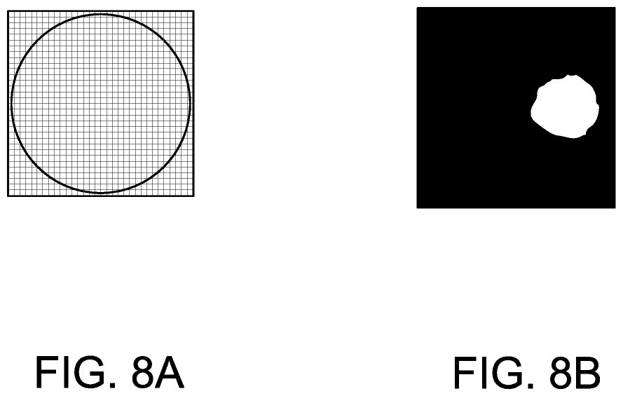

FIGS. 8(A) & 8(B) elucidates the method of inference of signals received from ECT as described in FIG. 7. A cross-section of the bore-well pipe encompassing a particle detector (120) or ECT sensor comprises a number of uniformly distributed electrodes outside the bore-well pipe. FIG. 8(A) illustrates a pixel arrangement for obtaining the image of the solid particles by the tomography measurement device within the flow pipe cross-sectional area. FIG. 8(B) illustrates a detailed view of image of the solid particles obtained by the tomography measurement device (120) within the flow pipe, showing how a cluster or a single particle can be distinguished from the drilling fluid.

The cross-section is further divided into a square pixel, for example 32×32 as described in FIG. 8(A) of which 812 pixels lie within the bore-well pipe cross-section. The normalized relative permittivity is stored in each pixel which has a value in the range 0-1.

The ECT sensor is usually calibrated before deployed for operation where the medium with higher relative permittivity has a normalized value of 1 and the medium with a lower relative permittivity has a value of 0. During operation, a value in between 0 and 1 in each pixel indicates a mixture of the two phases in consideration. In MPD where water-based fluid stream is used for drilling, the drilling fluid forms the medium with higher relative permittivity due to the water content while the drilling cuttings form the medium with lower permittivity. The volume fraction or concentration Øₛ of the drilling cuttings in the solid-liquid mixture at a given sampling time is obtained from

$${∅}_{s} = 1 - \frac{1}{N} {\sum }_{i}^{n} {\sum }_{j}^{n} {M}_{k} \qquad ( 15 )$$

Where Mₖ(i,j) is an n×n matrix containing the stored pixel value at time, “k” recorded by either sensor (702A) or (702B) or their average, and N is the total number of pixels within the cross-section of bore-well pipe. The indices, “i” and “j” locates each pixel in the n×n plane.

The measurement of average drilling cutting or particle size with the ECT sensor is based on the particle clusters at any location within the pipe cross-section. FIG. 8(B) shows how the particle cluster can be distinguished from the continuous liquid medium using contrast with background. The region shaded with black color indicates the drilling fluid and the region with white color represents the contours of the particle or drilling cutting. The cross-sectional area of a particle is directly proportional to the number of pixels occupied by the particle cluster.

$${A}_{s} = A ( \frac{{N}_{s}}{N} ) \qquad ( 16 )$$

In Eq. (16), Aₛ[m²] is the cross-sectional area of the particle and Nₛ is the number of pixels occupied by the particle. For analysis, the particle is assumed spherical such that the particle diameter is calculated from Eq. (17). The actual shape of the drilling cutting particle relative to a sphere is based on the shape factor φₛ calculated as expressed in Eq. (18). The diameter dₛₚᵣ of the sphere is obtained by averaging the lengths of the major and minor axes of an ellipse that has the same normalized second central moments as the particle.

$${d}_{s} = \sqrt{\frac{4 {A}_{s}}{π}} \qquad ( 17 )$$

$${φ}_{s} = \frac{{d}_{s}^{2}}{{d}_{spr}^{2}} \qquad ( 18 )$$

So far, the means for measuring the total flowrate \dot{m}ₘ or Qₘ, the drilling cutting concentration Øₛ and one alternative means for calculating the gas volume fraction α_{g} in the present invention have been demonstrated. By applying conservation of volume fraction of all the phases, Eq. (19) can be derived as one part for calculating the volume fraction of drilling fluid α_{d} and volume fraction of oil αₒ in the water-continuous fluid stream, for example.

α_{g}+αₒ+α_{d}+αₛ=1 (19)

Further, Eq. (7)-(13) form the alternative first part for calculating the volume fractions of fluid stream components. Yet Eq. (14) and Eq. (19) may be combined with Eq. (7)-(13) along with one or two other equations hereafter derived to calculate volume fractions of gas α_{g}, drilling fluid α_{d}, oil αₒ and water α_{w} depending on the embodiment of the present invention henceforth disclosed.

By assuming that all the components of the fluid stream returning from the drilling well have the same flow velocity, i.e., neglecting the slip velocity between individual phases, Eq. (20) based on mass balance forms the second alternative part required for calculating the volume fractions of drilling fluid α_{d} and oil αₒ in the stream.

α_{g}ρ_{g}+α_{d}ρ_{d}+α_{d}ρ_{d}+αₛρₛ=ρm (20)

In one alternative embodiment of the present invention, the velocity of solid particles can be calculated. Firstly, a calculation is made to find the time delay required for a signal from the ECT sensor (702A) to reach a position where the ECT sensor (702B) is positioned, by cross correlating the signals generated in both parts (702A, 702B) of the particle detector (120) over a certain time frame. Secondly, the particle velocity in the fluid stream is calculated from,

$${v}_{s} = \frac{{L}_{e}}{{τ}_{e}} \qquad ( 21 )$$

where νₛ is the solid particle velocity, Lₑ is the distance separating the two sensors (702A) and (702B) apart and τₑ is the time lag or delay between the signals generated by the two parts (702A, 702B) of ECT sensor, and which is obtained by cross correlation.

Further, by neglecting the slip velocity between the individual phases in the fluid stream, the gas volume fraction α_{g} can be calculated from,

$${α}_{g} = 1 - \frac{{v}_{s}}{{v}_{m}} \qquad ( 22 )$$

where νₘ, =Qₘ/ρₘ is the flow mixture velocity in a pipe with diameter the same as where the ECT sensor parts (702A, 702B) are positioned. In lieu of the alternative embodiment heretofore disclosed, both the first impedance sensor (108) and second impedance sensor (118) or alike, are not required in accordance with the present invention. Therefore, only Eq. (14), Eq. (19) and Eq. (20)-(22) are applied for calculating the volume fraction of gas α_{g}, volume fraction of drilling fluid α_{d} and volume fraction of oil αₒ in the fluid stream.

In another alternative embodiment of the present invention, both the first (108) and second (118) impedance sensors are required in addition to the particle detector (120) consisting of two ECT sensors (702A, 702B) positioned in different planes. Further, the solid velocity νₛ calculated as in Eq. (22) can be assumed the same as the liquid velocity, i.e., oil, water, their mixture or alike, thereby accounting for slip velocity between the gas phase and other phases with equal flow velocity in the fluid stream returning from the drilling well. Combining with Eq. (7)-(13), Eq. (14), Eq. (19) and Eq. (21), Eq. (23) provides the second alternative part for calculating volume fraction of drilling fluid α_{d} and volume fraction of oil αₒ in the fluid stream.

$${α}_{g} {ρ}_{g} + {α}_{o} {ρ}_{o} + {α}_{d} {ρ}_{d} + {α}_{s} {ρ}_{s} = \frac{{v}_{m}}{{v}_{s}} ( {ρ}_{m} - {ρ}_{g} ) + {ρ}_{g} \qquad ( 23 )$$

Yet, in another alternative embodiment of the present invention, the signals from the two parts (118A, 118B) of second impedance sensor are cross correlated to calculate the fluid velocity, which can be attributed to gas phase, oil phase, water phase, drilling fluid phase, solid phase or one or more phase mixture. Further, the two parts of ECT sensors (702A, 702B) are used such that the solid velocity is calculated in accordance with Eq. (21).

Assuming that the velocity calculated from the signals of first and second parts of the second impedance sensor (118) is for the gas phase, reason being that gas is the lightest of all the phases in the fluid stream, thereby travelling faster to create signal disturbances captured by the cross-correlation calculation, the gas velocity ν_{g} is calculated from Eq. (24), where Lᵢ is the distance separating the two parts (118& 118B) of the second impedance sensor and τᵢ is the time lag or delay between the signals generated by the two parts (118A, 118B) of the sensor.

$${v}_{g} = \frac{{L}_{i}}{{τ}_{i}} \qquad ( 24 )$$

Further, inclusion of solid velocity and gas velocity in the present disclosure ensures that slip velocities between the different phases with wide differences in densities are accounted for; e.g., gas and liquid may flow at different velocities, likewise liquid and solid due to their differences in densities. In accordance with this invention, drilling fluid and oil for example, are considered as liquid flowing at the same velocity ν_{liq}. Considering a more general mass balance and volume balance at a point in time, Eq. (25) and Eq. (26) form the second and third alternative parts, respectively for calculating the volume fractions of drilling fluid α_{d} and oil αₒ contained in the flow mixture.

α_{g}ρ_{g}ν_{g}+αₛρₛνₛ+(α₀ρ₀+α_{d}ρ_{d})ν_{liq}=νₘ (25)

α_{g}ν_{g}+αₛνₛ+(αₒ+α_{d})ν_{liq}=νₘ (26)

Further, the density pₐ of drilling fluid is obtained from the first detector module (110) which can be a mass flowrate meter or any device installed to measure the density of fluid at the inlet of the drilling well as described in FIG. 1(A)-1(E); the drilling cutting density ρₛ is obtained by mud sample analysis; and the oil density ρₒ is based on the characterization of the reservoir. The gas density ρ_{g}, is related to the pressure p[Pa] indicated by the device PT and temperature t[C] indicated by the device TT at the measurement location shown in FIG. 1(E),

$${ρ}_{g} = \frac{{M}_{w} p}{zR ( t + 273.15 )} \qquad ( 27 )$$

where M_{w} [kg/kmol] is the gas molecular weight which is obtained by a gas specific gravity or density meter (125) described as part of sensing element (114) installed at the gas outlet of the gas separator (124), z[-] is the compressibility factor of the gas which also depends on the pressure and temperature at the measurement location and can be obtained from an appropriate equation of state (EOS), and R[J/(kmol-K)] is the universal gas constant.

An additional equation can be derived to present how the pressure loss Δpₜ measured across the venturi tube (200) depends on the density of the solid-liquid mixture. Following the energy balance across the venturi tube,

$${ρ}_{slurr} = \frac{2 Δ {p}_{L}}{{( \frac{{Q}_{m}}{{β}^{2} AK} ( 1 - {α}_{g} ) )}^{2} - 2 {g}_{z} L} \qquad ( 28 )$$

where L=L₁+L₂ is the distance between the connecting ports over which the differential pressure Δp_{L} is measured. The flow coefficient K depends on the venturi geometrical properties as well as the flow condition, and the appropriate correlation is obtained from experiments. Further, considering no slip velocity in the solid-liquid mixture, the density ρₛₗᵤᵣᵣ of the slurry in the flow stream can be obtained from

(1−α_{g})ρₛₗᵤᵣᵣ=αₒρₒ+α_{d}ρ_{d}+αₛρₛ (29)

Combining Eq. (28) and Eq. (29), the density pₛ of drilling cutting can be predicted.

$${ρ}_{s} = ( \frac{1 - {α}_{g}}{{α}_{s}} ) \{ \frac{2 Δ {p}_{L}}{{( \frac{{Q}_{m}}{{β}^{2} AK} ( 1 - {α}_{g} ) )}^{2} - 2 {g}_{z} L} \} - ( \frac{{α}_{o}}{{α}_{s}} {ρ}_{o} + \frac{{α}_{d}}{{α}_{s}} {ρ}_{d} ) \qquad ( 30 )$$

The drilling cutting density pₛ predicted from Eq. (30) is compared with the density obtained from the mud sample analysis for quality check and diagnosis. In the present invention, the influx of gas or oil from the formation fluid to the well-bore is calculated directly from physical measurement of behavior of the return flow stream for the different embodiments herein disclosed. No reference is made to the flowrate measured at the inlet to the well in detecting the kick and its size. The mass flow rate of the drilling fluid measured at inlet can still provide useful information about the loss of drilling fluid to reservoir or influx of water to the wellbore. The drilling fluid mass balance in circulation is expressed as

δ_{\dot{m}}=\dot{m}ᵢₙₗₑₜ−ρ_{d}α_{d}Qₘ (31)

where \dot{m}ᵢₙₗₑₜ is the mass flowrate of drilling fluid measured at inlet of the drilling well. When δ_{\dot{m}}=0, there is no loss in drilling fluid and there is no influx of liquid phase, say water from the formation fluid. When δ_{\dot{m}}>0, it indicates a loss in the drilling fluid and when δ_{\dot{m}}<0, it indicates influx of water from the formation fluid.

Based on these equations (1)-(31) in respect to different embodiments in accordance with the present invention, an algorithm is created for calculation of flowrates and volume fractions of gas, oil, water, drilling fluid and cuttings as well as calculation of the drilling cutting size. Other fluid variables including fluid density and density of mixture of liquid and drilling cuttings are also computed.

1. A system for real-time detection of a kick within a fluid stream in a drilling well, wherein the system comprising:
a first sensor unit positioned on top of the drilling well, wherein the first sensor unit includes:
a first impedance sensor for measuring value of one or more electrical parameters associated with the fluid stream entering the drilling well; and
a first detector for measuring value of one or more physical parameters associated with the fluid stream entering the drilling well; and
a second sensor unit positioned within the drilling well, wherein the second sensor unit includes:
a second detector for measuring value of one or more physical parameters associated with the fluid stream flowing out from the drilling well; and
a particle detector located below to the second detector, wherein the particle detector is used for measuring velocity, size and concentration of solids particles present within the fluid stream; and
a controller connected to the first sensor unit and the second sensor unit; wherein the controller obtains a value of the one or more electrical parameters, the one or more physical parameters, the velocity, size and concentration of solid particles, and further analyzes to detect the kick within the fluid stream of the drilling well.

2. The system in accordance with claim 1, wherein the one or more parameters include either flowrate, velocity, density, pressure, differential pressure, volume of a fluid phase within the fluid stream.

3. The system in accordance with claim 1, wherein the fluid phase includes a water component, a gas component, a solid component and an oil component within the fluid stream.

4. The system in accordance with claim 1, wherein the one or more electrical parameters include either of conductivity, impedance, permittivity and conductance associated with the fluid stream.

5. The system in accordance with claim 4, wherein the measurement of the one or more electrical parameters leads the way for measurement of volume fraction of a gas phase and velocity of any of the components or component mixtures within the fluid stream.

6. The system in accordance with claim 1, wherein the second detector includes:
a sensing element for measuring a density, a flowrate, a velocity, a volume fraction and a differential pressure of the fluid stream; wherein the sensing element includes:
a pair of vertical and parallel pipes placed within the drilling well at a specified distance.
a flow restrictor located within the pipes; wherein the flow restrictor is placed within each pipe for accelerating the flow of the fluid stream across the drilling well and thereby allowing the sensing element for measuring the differential pressure across the pipes; and
a second impedance sensor positioned inside opposite sides of the parallel pipes, wherein the second impedance sensor measures the value of one or more electrical parameters associated with the fluid stream.

7. The system in accordance with claim 1, wherein the fluid stream is a multiphase fluid stream.

8. The system in accordance with claim 1&7, wherein the fluid stream includes a gas phase, an oil phase, a water phase and a solid phase.

9. The system in accordance with claim 1, wherein the particle detector is either an electrical capacitance tomography (ECT), a double plane electrical capacitance tomography (ECT) sensor, an electrical resistance tomography (ERT), an X-ray tomography, an imaging device, and a camera positioned in one or more planes within the flow pipe.

10. The system in accordance with claim 1, wherein the flow-restrictor is either a venturi tube, a conical structure, an orifice plate and a wedge structure.

11. The system in accordance with claim 1, wherein the solid panicles are a drilling bit, drilling cuttings, a drill cutting, sand or alike.

12. The system in accordance with claims 1-11, wherein the system detects loss of the fluid during circulation within the drilling well by using the flowrate measurement by the first sensor unit and the second sensor unit.

13. The system in accordance with claim 1, wherein the system is applied in drilling operations where fluid stream used for drilling is either water-based or oil-based in composition.

14. The system in accordance with claim 1, wherein the system is used for measuring flowrates and fractions of gas phase, oil phase, drilling fluid and drilling cuttings in the fluid stream in real-time by using direct measurement of flow behavior and physical properties of the fluid stream.

15. The system in accordance with claim 1, wherein the system further includes a gas separator for removing gas phase from the fluid stream.

16. The system in accordance with claim 1, wherein the system further includes a flow conditioner located along a path of the fluid stream for homogenizing the fluid stream before entering the second sensor unit.

17. A system for real-time detection of a kick within a multiphase fluid stream in a drilling well, wherein the system comprising:
a first sensor unit positioned on top of the drilling well, wherein the first sensor unit includes:
a first impedance sensor for measuring impedance, conductivity, permittivity and conductance associated with the multiphase fluid stream entering the drilling well; and
a first detector for measuring a flowrate, a volume fraction, a density and a pressure associated with the multiphase fluid stream entering the drilling well; and
a second sensor unit positioned within the drilling well, wherein the second sensor unit includes:
a second detector for measuring value of a flowrate, a velocity, a volume fraction, a density and a pressure associated with the fluid stream flowing out from the drilling well, where in the second detector includes:
a sensing element for measuring the flowrate, the density and the pressure of the multiphase fluid stream; wherein the sensing element includes: a pair of vertical and parallel pipes placed within the drilling well at a specified distance.
a flow restrictor located within the pipes; wherein the flow restrictor placed within each pipe for accelerating the flow of the fluid stream across the drilling well and thereby allowing the sensing element for measuring the differential pressure and the flowrate across the pipes; and
a second impedance sensor for measuring the impedance, conductivity, permittivity, the conductance and velocity of any of the components or component mixture associated with the fluid stream.
a particle detector located below to the second detector, wherein the particle detector is used for measuring velocity, size and concentration of solids particles present within the fluid stream; and
a controller connected to the first sensor unit and the second sensor unit; wherein the controller obtains a value of the impedance, the conductivity, the conductance, the permittivity, the flowrate, the velocity, the density and the pressure, size and concentration of solid particles from the first sensor unit and the second sensor unit and further analyzes to detect the kick within the multiphase fluid stream of the drilling well.

18. The system in accordance with claim 17, wherein the impedance, the conductivity, the permittivity, the conductance measured by the second detector leads the way for measurement of the volume fraction of a gas phase and velocity of any of the components or component mixture within the multiphase fluid stream.

19. The system in accordance with claim 17, wherein the system further includes a flow conditioner located along a path of the multiphase fluid stream for homogenizing the multiphase fluid stream before entering the second sensor unit.

20. The system in accordance with claim 17, wherein the system further includes a gas separator for removing gas phase from the multiphase fluid stream.

21. A method for measuring a kick of a multiphase fluid stream for a drilling operation, wherein the method includes:
measuring one or more parameters associated with the multiphase fluid stream at an inlet point of a drilling well.
conditioning the multiphase fluid stream flowing out the drilling well for homogenizing the multiphase fluid stream.
monitoring the one or more parameters associated with a fluid in the multiphase fluid stream flowing out the drilling well in real-time.
applying the set of real-time data assessed from the sensors to a processer; and
estimating the well condition by using the real-time values associated with the multiphase fluid stream to yield a probability of an occurrence of a kick in the drilling operation.

22. The method in accordance with claim 21, wherein the one or more parameters includes a flowrate, velocity, density, pressure, differential pressure, permittivity, conductivity and volume fraction of a fluid, oil, gas within the fluid stream, and size and concentration of the solid particles associated with the fluid stream.

23. The method in accordance with claim 21, wherein the multiphase fluid includes oil, water, gas and solid particles.

24. A system for real-time detection of a kick within a multiphase fluid stream in a drilling well, wherein the system comprising:
a first sensor unit positioned on top of the drilling well, wherein the first sensor unit includes:
a first impedance sensor for measuring impedance, conductivity, permittivity and conductance associated with the multiphase fluid stream entering the drilling well; and
a first detector for measuring a flowrate, a volume fraction, a density and a pressure associated with the multiphase fluid stream entering the drilling well; and
a second sensor unit positioned within the drilling well, wherein the second sensor unit includes:
a second detector for measuring value of a flowrate, velocity, a volume fraction, a density and a pressure associated with the fluid stream flowing out from the drilling well, where in the second detector includes:
a sensing element for measuring the flowrate, the density and the pressure of the multiphase fluid stream; wherein the sensing element includes: a pair of vertical and parallel pipes placed within the drilling well at a specified distance; and
a flow restrictor located within the pipes; wherein the flow restrictor placed within each pipe for accelerating the flow of the fluid stream across the drilling well and thereby allowing the sensing element for measuring the differential pressure and the flowrate across the pipes;
a particle detector located below to the second detector, wherein the particle detector is used for measuring velocity, size and concentration of solids particles present within the fluid stream; and
a controller connected to the first sensor unit and the second sensor unit; wherein the controller obtains a value of the impedance, the conductivity, the conductance, the permittivity, the flowrate, the velocity, the density and the pressure, size and concentration of solid particles from the first sensor unit and the second sensor unit and further analyzes to detect the kick within the multiphase fluid stream of the drilling well.
